(19) United States
(12) Patent Application Publication
(10) Pub. No.: US 2008/0201288 A1
(43) Pub. Date: Aug. 21, 2008

(54) METHOD, SYSTEM AND PROGRAM PRODUCT FOR IDENTIFYING CACHING OPPORTUNITIES

(75) Inventors: Gennaro A. Cuomo, Cary, NC (US); Thomas R. Gissel, Apex, NC (US); Stephen Rees, Bowmanville (CA); Timothy J. Vincent, Toronto (CA)

Correspondence Address: SILVY ANNA MURPHY, 100 TURNBERRY LANE, CARY, NC, 27518, US

(73) Assignee: INTERNATIONAL BUSINESS MACHINES CORPORATION, Armonk, NY (US)

(21) Appl. No.: 11/675,142

(22) Filed: Feb. 15, 2007

(51) Int. Cl. G06N 5/02; G06F 3/01

(52) U.S. Cl. 706/47; 715/709

(57) ABSTRACT

A method, system and program product for identifying caching opportunities is provided. The method includes identifying one or more data sources stored on a database system that are utilized by an application, establishing a pre-set read-update ratio threshold for data accessed from a data source, and tracking the read-update ratio threshold for data accessed from the data source, such that exceeding the pre-set read-update ratio threshold for the data accessed identifies a caching opportunity. The method further includes defining an action to be taken when the pre-set read-update ratio threshold for the data accessed from the data source has been exceeded and taking the action defined when the pre-set read-update ratio threshold for the data accessed from the data source has been exceeded. The action defined includes either advising a user of an opportunity to cache the data accessed or automatically caching the data accessed from the data source.

### FIELD OF THE INVENTION

The present invention relates to a method, system and computer program product for identifying caching opportunities. In particular, the present invention relates to a method, system and computer program product for advising a user of an opportunity to cache data and to automatically cache the data when a certain threshold has been met or to cache the data when the user decides to cache the data.

### BACKGROUND OF THE INVENTION

In today's business environment, applications are increasingly hosted on different physical systems than the data they utilize. For instance, in a business environment, the applications may be hosted on an application tier, whereas, the data that these applications utilize may be hosted on a data tier. The cost of getting data from such a distributed tier is expensive. Caching is one technique used to minimize the expense of keeping data on a separate tier of the environment. The complex task of deciding what to cache is usually decided by someone who has an intimate knowledge of the application and its data access pattern, given that deciding what to cache is a delicate balance between performance and costs. If not enough data is cached, then performance improvement opportunities will be missed. If caching is used frequently, that is, a cache is updated too frequently, then the cost may become too prohibitive. As such, there is a need for a business and/or organization to provide a cost-effective way of caching data and improving cache accuracy.

### SUMMARY OF THE INVENTION

In a first aspect of the invention, there is provided a method for identifying caching opportunities. The method comprises identifying at least one data source among a plurality of data sources utilized by an application, the plurality of data sources being stored on a computer system, establishing a pre-set respective read-update ratio threshold for respective data accessed from a respective data source among the plurality of data sources, wherein exceeding the pre-set respective read-update ratio threshold for the respective data accessed identifies a caching opportunity, defining an action to be taken when the pre-set respective read-update ratio threshold for the respective data accessed from the respective data source has been exceeded and taking the action defined when the pre-set respective read-update ratio threshold for the respective data accessed from the respective data source has been exceeded. The taking the action step further comprises checking the action defined before taking the action defined when the read-update ratio threshold for the respective data accessed from the respective data source has been exceeded. The method further comprises tracking a respective read-update ratio threshold for data accessed from each data source among the plurality of data sources stored on the computer system and determining when the pre-set respective read-update ratio threshold for the respective data accessed from the respective data source among the plurality of data sources is exceeded. In an embodiment, the action defined to be taken when the pre-set respective read-update ratio threshold for the respective data accessed from the respective data source has been exceeded comprises at least one of: advise a user of an opportunity to cache the respective data accessed from the respective data source and automatically cache the respective data accessed from the respective data source. In an embodiment, if the action defined is to advise the user of the opportunity to cache the respective data when the pre-set respective read-update ratio threshold for the respective data accessed from the respective data source has been exceeded, the method further comprises sending notification to the user the respective read-update ratio threshold for the respective data accessed from the respective data source has been exceeded and inquiring whether the user wants to cache the respective data from the respective data source. Further, in an embodiment, if the user wants to cache the respective data from the respective data source, the method further comprises receiving an affirmative response from the user to cache the respective data from the respective data source and caching the respective data from the respective data source.

In another aspect of the invention, there is provided a system for identifying caching opportunities. The system comprises an application server configured to ascertain one or more data sources utilized by an application, the application server being configured to receive a pre-set respective read-update ratio threshold for respective data accessed from a respective data source of the one or more data sources, the one or more data sources being stored in a database, a database manager configured to track a respective read-update ratio threshold for data accessed from each data source of the one or more data sources in the database and a caching prospector tool configured to take a defined action when the pre-set respective read-update ratio threshold for the respective data accessed from the respective data source has been exceeded, wherein exceeding the pre-set respective read-update ratio threshold for the respective data accessed identifies a caching opportunity. In an embodiment, the application server is further configured to register with the database manager to receive notification when the pre-set respective read-update ratio threshold for the respective data accessed from the respective data source has been exceeded. The caching prospector tool is further configured to send notification to the application server when the pre-set respective read-update ratio threshold for the respective data accessed from the respective data source has been exceeded. In an embodiment, the defined action to be taken when the respective read-update ratio threshold for the respective data accessed from the respective data source has been exceeded comprises either of advising a user of an opportunity to cache the respective data accessed from the respective data source or of automatically caching the respective data accessed from the respective data source. In an embodiment, if the defined action is to advise the user of the opportunity to cache the data, the caching prospector tool is further configured to inquire whether the user wants to cache the respective data from the respective data source when the respective read-update ratio threshold for the data accessed from the respective data source has been exceeded. In an embodiment, the caching prospector tool is further configured to cache the respective data from the respective data source upon receiving an affirmative response from the user to cache the respective data. In an embodiment, if the defined action is to automatically cache the respective data from the respective data source, the caching prospector tool automatically caches the respective data from the respective data source when the respective read-update ratio threshold for the respective data accessed from the respective data source has been exceeded.

In yet another aspect of the invention, there is provided a computer program product for identifying caching opportunities. The computer program product comprises a computer readable medium, first program instructions to establish a respective read-update ratio threshold for respective data accessed from a respective data source among a plurality of data sources stored in a database, wherein exceeding the read-update ratio threshold for the respective data accessed identifies a caching opportunity. The computer program product further comprises second program instructions to define an action to be taken when the respective read-update ratio threshold for the respective data accessed from the respective data source has been exceeded and third program instructions to take the action defined when the read-update ratio threshold for the respective data accessed from the respective data source has been exceeded and wherein the first, second and third program instructions are stored on the computer readable medium. Further, the computer program product further comprises fourth program instructions to track a respective read-update ratio threshold for data accessed from each data source among the plurality of data sources stored in the database and wherein the fourth program instructions are stored on the computer readable medium. In an embodiment, the first program instructions include instructions to identify at least one data source among the plurality of data sources utilized by an application and in an embodiment, the action defined to be taken when the respective read-update ratio threshold for the respective data accessed from the respective data source has been exceeded comprises either of advising a user of an opportunity to cache the respective data accessed from the respective data source and of automatically caching the respective data accessed from the respective data source. In an embodiment, if the action defined is to advise the user of the opportunity to cache the respective data when the respective read-update ratio threshold for the respective data accessed from the respective data source has been exceeded, the third program instructions include instructions to send notification to the user that the respective read-update ratio threshold for the respective data accessed from the respective data source has been exceeded and to inquire whether the user wants to cache the respective data from the respective data source. In an embodiment, if the user sends an affirmative response to cache the respective data from the respective data source, the third program instructions include instructions to cache the respective data from the respective data source upon receiving the affirmative response from the user to cache the respective data. In an embodiment, if the action defined is to automatically cache the respective data when the respective read-update ratio threshold for the respective data accessed from the respective data source has been exceeded, the third program instructions include instructions to automatically cache the respective data from the respective data source.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1A depicts a flowchart outlining the steps carried out by a caching prospector tool in advising a user of caching opportunities, in accordance with an embodiment of the present invention.

FIG. 2A depicts a flowchart outlining the steps carried out by a caching prospector tool in automatically caching data specified by a user, in accordance with an embodiment of the present invention.

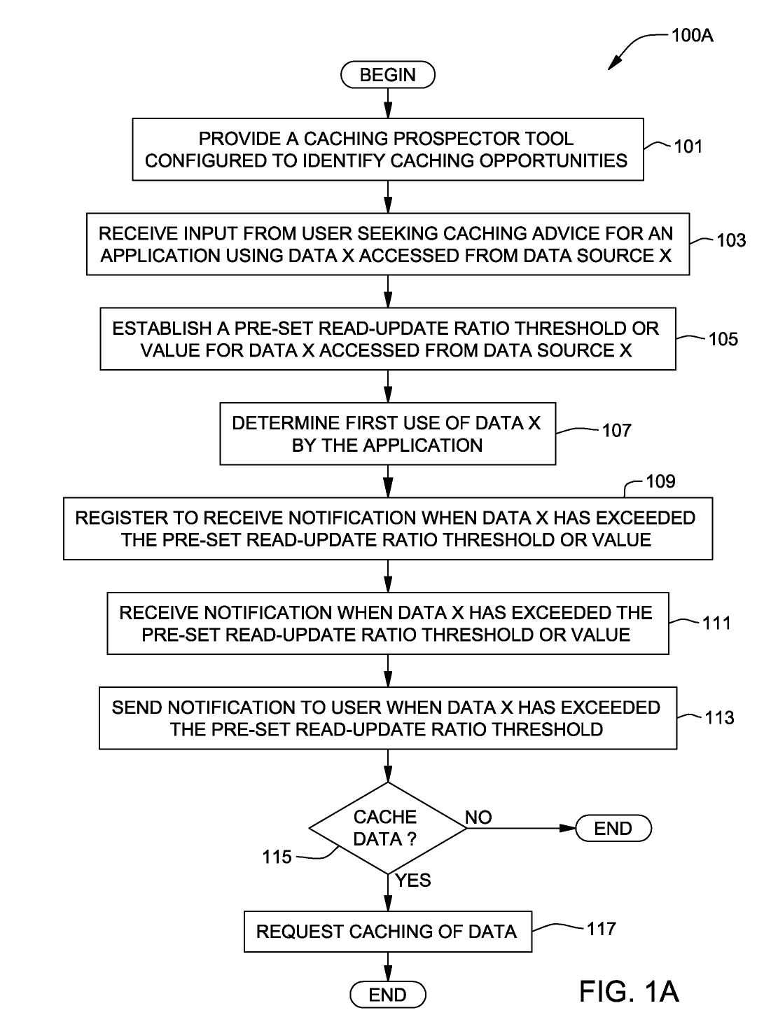

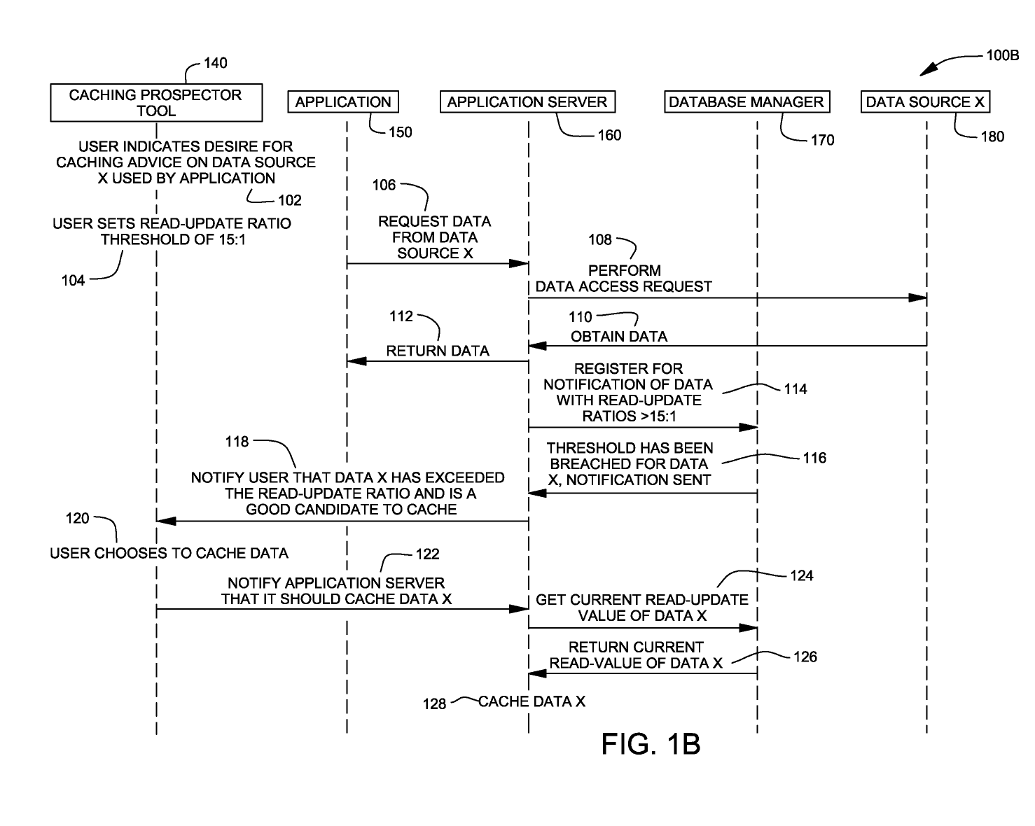

FIG. 1B depicts a flowchart outlining the steps involved in identifying caching opportunities by advising a user of an opportunity to cache data, in accordance with an embodiment of the present invention.

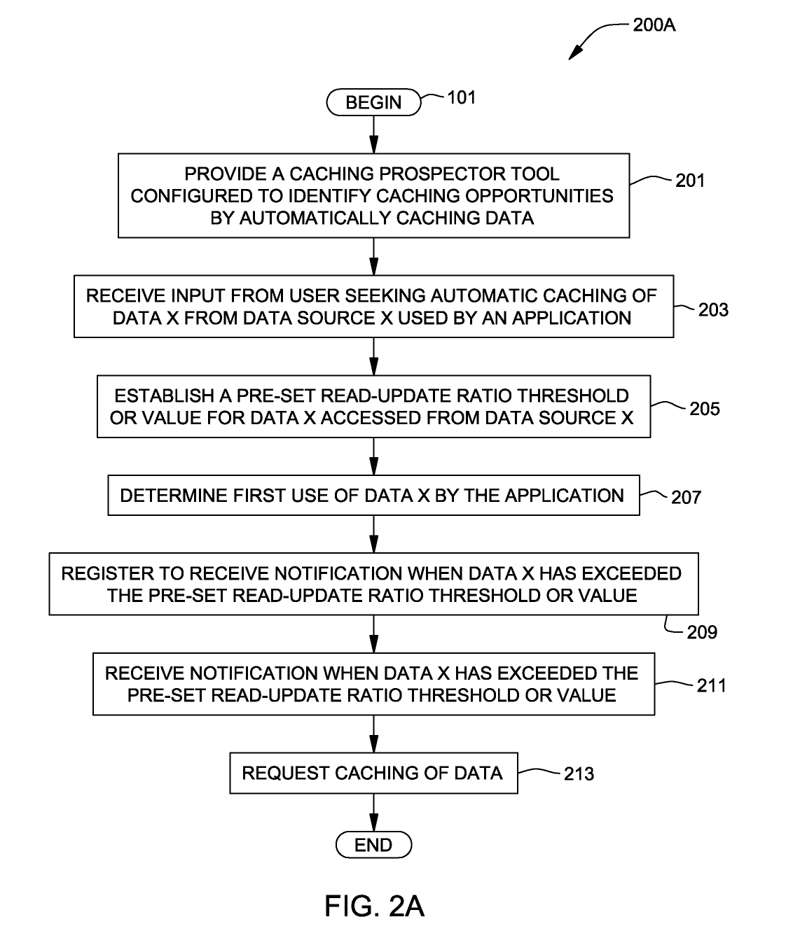

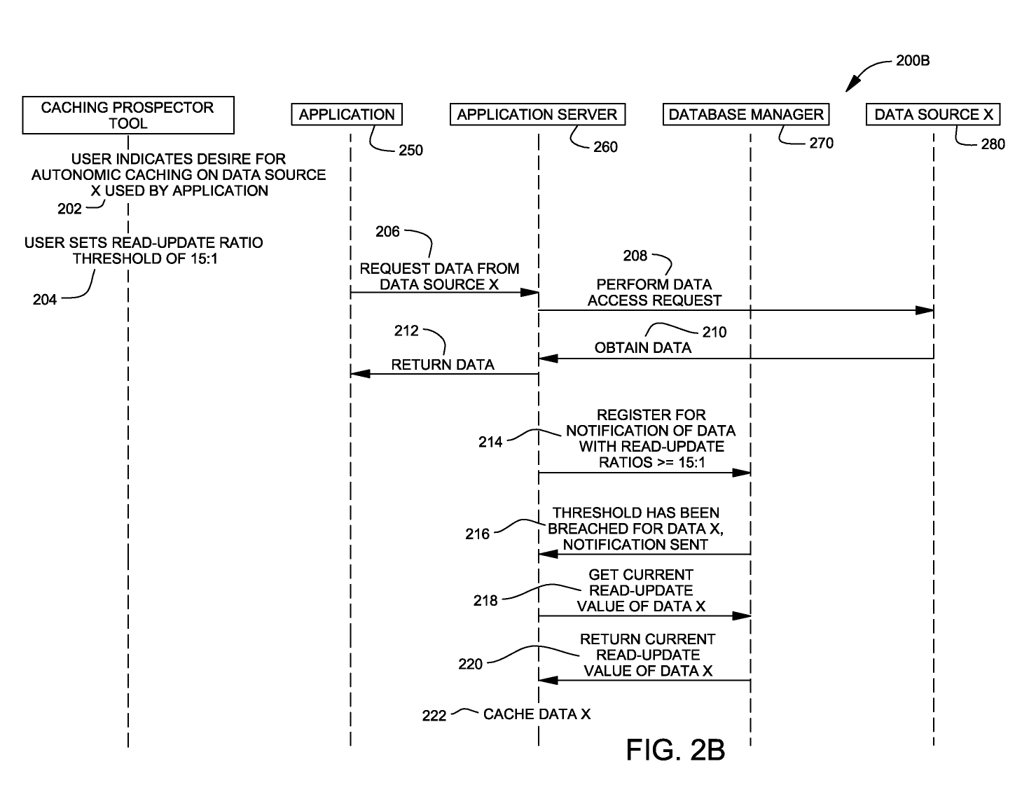

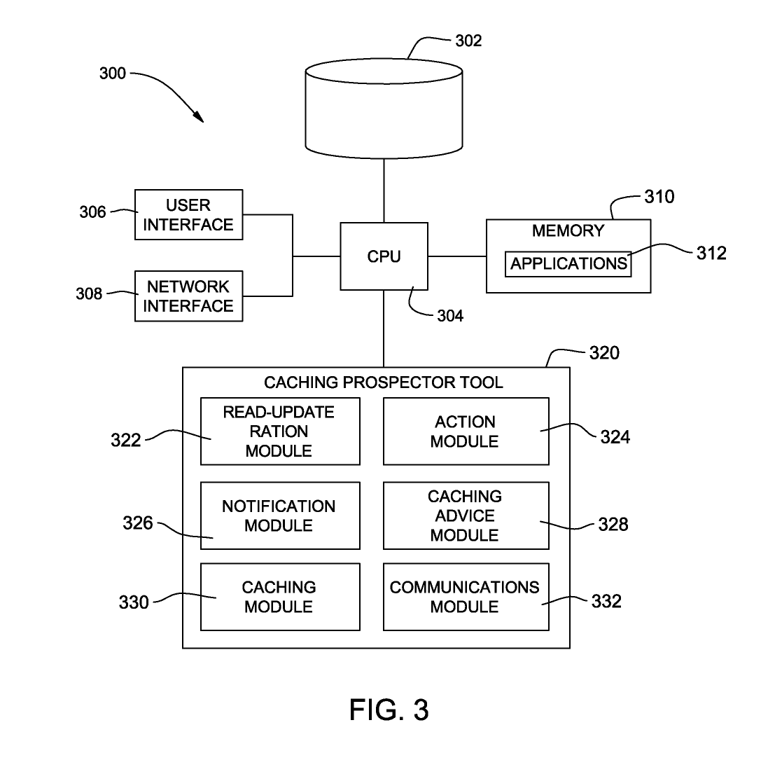

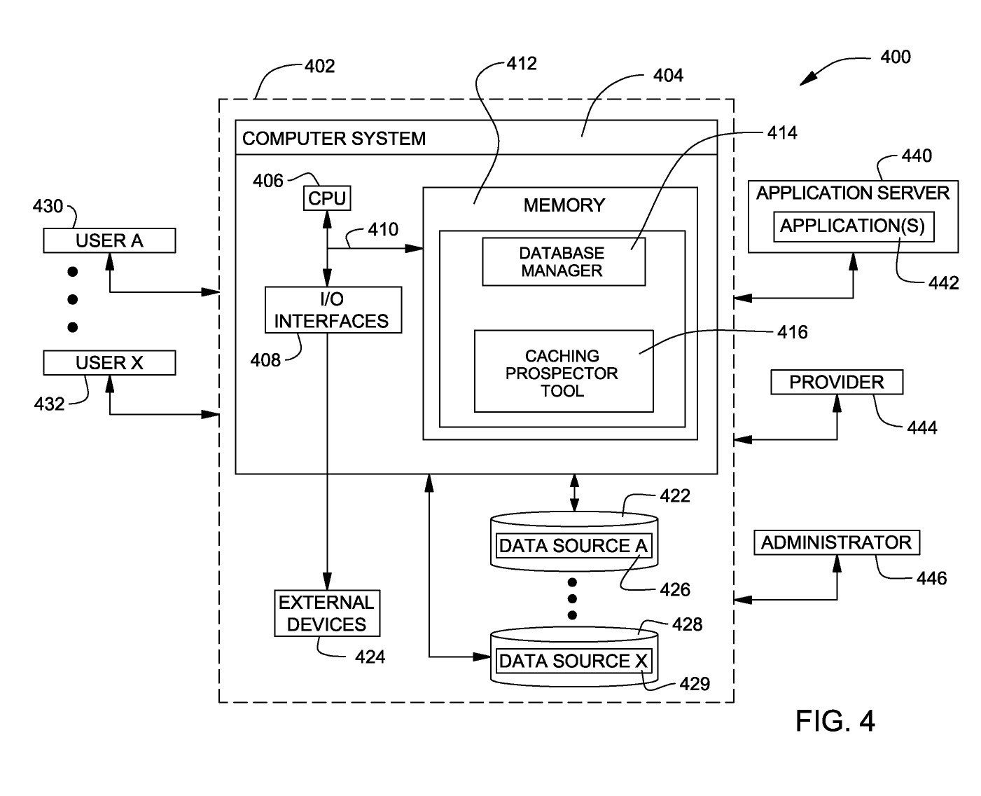

FIG. 2B depicts a flowchart outlining the steps involved in identifying caching opportunities by autonomically caching data when a pre-set read-update ratio threshold has been exceeded, in accordance with an embodiment of the present invention.

FIG. 3 is a schematic block system diagram illustrating an embodiment of a system for identifying caching opportunities, including advising a user of an opportunity to cache data and/or for autonomically caching data when a pre-set read-update ratio threshold has been exceeded, in accordance with an embodiment of the present invention.

FIG. 4 is a schematic block system diagram illustrating an embodiment of a computer infrastructure for identifying caching opportunities, including advising a user of an opportunity to cache data and/or for autonomically caching data when a pre-set read-update ratio threshold has been exceeded, in accordance with an embodiment of the present invention.

### BEST MODE FOR CARRYING OUT THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network.

Furthermore, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

In one embodiment, the invention provides a method for identifying caching opportunities, using a caching prospector tool, which is described herein below and, in particular, with respect to FIG. 3. Reference is now made to FIG. 1A and 2A, which depict flowcharts outlining different embodiments of a method of identifying caching opportunities, using a caching prospector tool. In particular, FIG. 1A shows the process of identifying caching opportunities by advising a user of a caching opportunity. As shown in FIG. 1A, the process of identifying caching opportunities begins in step 101 with providing a caching prospector tool configured to identify caching opportunities. The caching prospector tool is configured to receive input in step 103 from a user seeking caching advice for an application using data, for instance, data X, accessed from a data source, for instance, data source X. Further, the user enters or establishes in step 105 in the caching prospector tool a pre-set read-update ratio threshold or value for the data X accessed from the data source X, as discussed herein below with respect to FIGS. 1B and 2B. Furthermore, the caching prospector tool is configured to determine in step 107 first use of data X by the application and is configured to register in step 109 to receive notification when data X has exceeded the pre-set read-update ratio threshold or value set in step 10. Moreover, in step 111, the caching prospector tool receives notification when data X has exceeded the pre-set read-update ratio threshold or value set in step 105. The caching prospector tool sends notification to the user in step 113 when the pre-set read-update ratio threshold value for data x has been exceeded. In step 115, the caching prospector tool inquires whether or not the data X should be cached. If the user responds affirmatively that data X should be cached, the caching prospector tool requests in step 117 the caching of data X from data source X, as explained herein below with respect to FIG. 2B, ending the process.

Further, as shown in FIG. 2A, the process of identifying caching opportunities begins in step 201 with providing a caching prospector tool configured to identify caching opportunities and to automatically cache data specified by a user. The caching prospector tool is configured to receive input in step 203 from a user seeking to automatically cache data, for instance, data X, accessed from data source, for instance, data source X, that is used by an application. Further, the user enters or establishes in step 205 in the caching prospector tool a pre-set read-update ratio threshold or value for the data X accessed from the data source X, as discussed herein below with respect to FIGS. 1B and 2B. Furthermore, the caching prospector tool is configured to determine in step 207 first use of data X by the application and is configured to register in step 209 to receive notification when data X has exceeded the pre-set read-update ratio threshold or value set in step 205. Furthermore, the caching prospector tool is configured to receive notification in step 211 when data X has exceeded the pre-set read-update ratio threshold or value set in step 205. The caching prospector tool receives notification in step 207 when the pre-set read-update ratio threshold value for data x has been exceeded. Accordingly, in step 213, the caching prospector tool requests the caching of data X from data source X, as explained herein below with respect to FIG. 2B, ending the process.

Reference is now made to FIGS. 1B and 2B, which together outline various aspects of the method for identifying caching opportunities, using the caching prospector tool, including advising a user of an opportunity to cache data (as described herein above with respect to FIG. 1A) and/or for autonomically or automatically caching data when a pre-set read-update ratio threshold or value or limit has been exceeded (as described hereinabove with respect to FIG. 2A), in accordance with an embodiment of the present invention. Turning to FIG. 1B, reference numeral 100B outlines a method for identifying caching opportunities and advising a user of an opportunity to cache data, using a caching prospector tool 140. The method begins in step 102 with a user, such as, a client utilizing the caching prospector tool 140 or an administrator for an application server 160, indicating a desire for receiving caching advice for data that is accessed frequently by an application 150 running on the application server 160 from a data source, for instance, data source X (reference numeral 180). For example, the data source X (reference numeral 180) may be a database that is used by the application 150. In particular, if the user and/or administrator desires caching advice with respect to data that is accessed or used by an application 150 from a particular data source, then the user and/or administrator enters the information for the data source X (reference numeral 180) into the caching prospector tool 140, which, in an embodiment, is deployed on the application server 160. Further, if the user and/or administrator wishes to receive notification regarding data that is frequently accessed from a particular data source, such as, data source X (reference numeral 180), then the user and/or administrator enters or inputs, in step 104, into the caching prospector tool 140, a pre-set or prescribed read-update ratio threshold or limit, for example, a read-update ration of 15:1, such that the user and/or administrator can receive automatic notification when data, data X, has exceeded the pre-set read-update ratio threshold or limit. In particular, the caching prospector tool 140 deployed on the application server 160 determines or identifies, in step 106, first use of data source X (reference numeral 180), for instance, when application 150 sends a request to the application server 160 to retrieve data from data source X (reference numeral 180), the caching prospector tool 140 identifies or determines that the application server 160 is performing the data access in step 108 and is obtaining the data requested in step 110, which is returned, in step 112, from the data source X (reference numeral 180) to the application 150. As such, the caching prospector tool 140 registers the application server 160, in step 114, with a database manager 170, which is configured to track read-update ratio thresholds for data accessed or used by an application, for instance, application 150 from a data source, such as, the data source X (reference numeral 180). In particular, the caching prospector tool 140 sends to or registers with the database manager 170 the pre-set read-update ratio threshold or limit, in particular, the 15:1 read-update ratio value set by the user and/or administrator, such that the database manager 170 can begin tracking all data accessed by the application 150 from data source X (reference numeral 180). Thus, in this case, when the pre-set 15:1 read-update ratio threshold or limit for data, for instance, data X, that is accessed from the data source X has been exceeded, the database manager 170 sends, in step 116, a notification to the caching prospector tool 140 running on the application server 160 that the read-update ratio threshold has been exceeded. Accordingly, the caching prospector tool 140, sends a notification to the user and/or administrator, in step 118, stating that the read-update ratio threshold of 15:1 for data X accessed from data source X (reference numeral 180) has been exceeded and advises the user and/or administrator that data X is a good candidate to cache. In step 120, the user and/or administrator upon receiving notification can choose to cache data X and, if so, a notification or affirmative response is sent by the user and/or administrator in step 122 to cache data X. If the caching prospector tool 140 receives an affirmative response from the user and/or administrator, the caching prospector tool 140 requests, in step 124, the current read-update ratio threshold or value for data X from the database manager 170 and the current read-update ratio threshold or value is returned, in step 126, to the caching prospector tool 140, which issues a request to the application server 150 to cache data X in step 128. If on the other hand, the user and/or administrator decide not to cache data X, then, the process ends with the user and/or administrator receiving notification in step 122.

Turning to FIG. 2B, reference numeral 200B outlines a method of identifying caching opportunities and autonomically or automatically caching data when a pre-set read-update ratio threshold or value or limit has been exceeded, in accordance with an embodiment of the present invention. The method begins similar to that shown in FIG. 1B, with a user, such as, a client utilizing the caching prospector tool 240 or an administrator for an application server 260, indicating in step 202 a desire for automatically or autonomically caching data that is frequently accessed by an application 250 running on the application server 260 from a data source, for instance, data source X (reference numeral 280). For example, the data source X (reference numeral 280) may be a database that is used by the application 250. In particular, if the user and/or administrator desires to automatically or autonomically cache data that is accessed or used frequently by an application 250 from a particular data source X (reference numeral 280), then the user and/or administrator enters the information for the data source X (reference numeral 280) into the caching prospector tool 240, which, in an embodiment, is deployed on the application server 260. Further, the user and/or administrator enters or inputs, in step 204, into the caching prospector tool 240, a pre-set or prescribed read-update ratio threshold or limit, for example, a read-update ration of 15:1, such that the caching prospector tool 140 can automatically or autonomically cache a particular data, data X, when the pre-set read-update ratio threshold or limit for data X has been exceeded. In particular, the caching prospector tool 240 deployed on the application server 260 determines or identifies, in step 206, first use of data source X (reference numeral 280), for instance, when application 250 sends a request to the application server 260 to retrieve data from data source X (reference numeral 280), the caching prospector tool 240 identifies or determines that the application server 260 is performing the data access in step 208 and is obtaining the data requested in step 210, which is returned, in step 212, from the data source X (reference numeral 280) to the application 250. As such, the caching prospector tool 240 registers the application server 260, in step 214, with a database manager 270, which is configured to track read-update ratio thresholds for data accessed or used by an application, for instance, application 250, from a data source, such as, the data source X (reference numeral 280). In particular, the caching prospector tool 240 sends to or registers with the database manager 270 the pre-set read-update ratio threshold or limit, in particular, the 15:1 read-update ratio value set by the user and/or administrator, such that the database manager 270 can begin tracking all data accessed by the application 250 from data source X (reference numeral 280). Thus, in this case, when the preset 15:1 read-update ratio threshold or limit for a data, for instance, data X, that is accessed from the data source X has been exceeded, the database manager 270 sends, in step 216, a notification to the caching prospector tool 240 running on the application server 260 that the read-update ratio threshold has been exceeded. The caching prospector tool 240 requests, in step 218, the current read-update ratio threshold or value for data X from the database manager 270 and the database manager 270 returns or sends to the caching prospector tool 240, the current read-update ratio threshold or value in step 220, so that the caching prospector tool 240 can automatically cache data X in step 222.

Accordingly, the invention provides a method of identifying caching opportunities, using the caching prospector tool, whereby the user and/or administrator can choose based on the information entered in the user defined settings of the caching prospector tool to automatically or autonomically cache data when a prescribed or pre-set read-update ratio threshold or value has been exceeded or to be advised of caching opportunities when a preset read-update ratio threshold has been exceeded, such that, the user and/or administrator can decide whether or not to cache the data. Further, a user and/or administrator can define pre-set read-update ratio thresholds or values for data accessed frequently by one or more applications from one or more data sources, such that, the user and/or administrator can either choose to automatically or autonomically cache any data that exceeds the pre-set read-update ratio threshold or to be advised of caching opportunities when any data exceeds the pre-set read-update ratio threshold or value. Further yet, a user and/or administrator can choose to be advised of caching opportunities for data accessed from a set of data sources (one or more data sources) and to automatically or autonomically cache data accessed from another set of data sources.

Reference is now made to FIG. 3, which illustrates an embodiment of a system for identifying caching opportunities, including advising a user and/or administrator of an opportunity to cache data and/or for autonomically caching data when a pre-set read-update ratio threshold or limit or value has been exceeded, in accordance with an embodiment of the present invention. Turning to FIG. 3, FIG. 3 is a schematic block system diagram illustrating one embodiment of a system or server 300 having a caching prospector tool or component 320 deployed thereon. In an embodiment, the caching prospector tool 320 is configured to identify caching opportunities, including advising a user and/or administrator of an opportunity to cache data and/or for autonomically or automatically caching data when a pre-set read-update ratio threshold has been exceeded. Preferably, the computer system 300 is a server, for instance, an application server that is dedicated to run software application(s) 312 and uses the caching prospector tool 320, deployed thereon, to identify caching opportunities. The computer system 300 includes a central processing unit (CPU) 304, a local storage device 302, a user and/or administrator interface 306, a network interface 308, and a memory 310. The CPU 304 is configured generally to execute operations within the system or server 300. The user interface 306, in one embodiment, is configured to allow a user and/or administrator to interact with the system 300, including allowing input data and commands from a user and/or administrator, such as, establishing a pre-set read-update ratio threshold or value for caching data and/or for autonomically caching data. The network interface 308 is configured, in one embodiment, to facilitate network communications of the system 300 over a communications channel of a network (not shown in any of the drawings). In an embodiment, the local memory 310 is configured to store and run the application(s) 312.

In one embodiment, as shown in FIG. 3, the caching prospector tool 320 which runs on the server or system 300 comprises a logic unit that contains a plurality of modules configured to functionally execute the necessary steps of identifying caching opportunities. In particular, the caching prospector tool 320 includes a read-update ratio threshold or value module 322, an action module 324, a notification module 326, a caching advice module 328, a caching module 330 and a communications module 332. The read-update ratio module 322 of the caching prospector tool 320 is configured to receive input from a user and/or administrator for establishing a read-update ratio threshold or value for a respective data (data X) accessed from a respective data source, such as a respective database. The action module 324 is configured to receive input from a user and/or administrator for defining an action to be taken when the read-update ratio threshold or value established for the respective data accessed from the respective data source has been exceeded, such as, notify the user and/or administrator or autonomically cache the respective data. Further, the notification module 326 is configured to receive notification from the database manager (not shown in FIG. 3) when the read-update ratio threshold or value established for the respective data accessed from the respective data source has been exceeded. The caching advice module 328 is configured to send caching advice to the user and/or administrator that there is an opportunity to cache the respective data, if the user and/or administrator have requested such caching advice. Further, the caching advice module 328 is configured to inquire as to what action should be taken, that is, whether or not the user and/or administrator wishes to cache the respective data. Moreover, the caching module 330 is configured to cache the respective data accessed from the respective data source upon receiving confirmation from the user and/or administrator to cache the respective data source and/or is configured to automatically or autonomically cache the respective data accessed from the respective data source when the read-update ratio threshold established by the user and/or administrator has been exceeded and the user and/or administrator has indicated that any data that exceeds the read-update ratio threshold is to be cached. Further, the communications module 332 is configured to permit communication between the various modules of the caching prospector tool 320 and the various components, such as, the various applications 312 running on the server 300.

In yet another embodiment, the invention provides a computer program product for identifying caching opportunities. Preferably, the computer program product comprises a form accessible from the computer-usable or computer-readable medium, which provides program codes or instructions for use by or in connection with a computer or any instruction execution system. For the purposes of this description, a computer-usable or computer readable medium can be any apparatus that can contain, store, communicate, propagate, or transport the codes or instructions for use by or in connection with the instruction execution system, apparatus, or device. Preferably, the medium can include an electronic, magnetic, optical, electromagnetic, infrared, or semiconductor system (or apparatus or device) or a propagation medium. More preferably, the computer-readable medium can include a semiconductor or solid state memory, magnetic tape, a removable computer diskette, a random access memory (RAM), a read-only memory (ROM), a rigid magnetic disk and an optical disk. Further, examples of optical disks include compact disc-read only memory (CD-ROM), compact disc-read/write (CD-R/W) and digital versatile/video disc (DVD). The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The computer program product further comprises first program instructions to establish a respective read-update ratio threshold for respective data accessed from a respective data source among a plurality of data sources stored in a database, wherein exceeding the read-update ratio threshold for the respective data accessed identifies a caching opportunity. The computer program product further comprises second program instructions to define an action to be taken when the respective read-update ratio threshold for the respective data accessed from the respective data source has been exceeded and third program instructions to take the action defined when the read-update ratio threshold for the respective data accessed from the respective data source has been exceeded. Further, the computer program product further comprises fourth program instructions to track a respective read-update ratio threshold for data accessed from each data source among the plurality of data sources stored in the database. In an embodiment, the first program instructions include instructions to identify at least one data source among the plurality of data sources utilized by an application and in an embodiment, the action defined to be taken when the respective read-update ratio threshold for the respective data accessed from the respective data source has been exceeded comprises either of advising a user and/or administrator of an opportunity to cache the respective data accessed from the respective data source and of automatically caching the respective data accessed from the respective data source. In an embodiment, if the action defined is to advise the user and/or administrator of the opportunity to cache the respective data when the respective read-update ratio threshold for the respective data accessed from the respective data source has been exceeded, the third program instructions include instructions to send notification to the user that the respective read-update ratio threshold for the respective data accessed from the respective data source has been exceeded and to inquire whether the user wants to cache the respective data from the respective data source. In an embodiment, if the user sends an affirmative response to cache the respective data from the respective data source, the third program instructions include instructions to cache the respective data from the respective data source upon receiving the affirmative response from the user to cache the respective data. In an embodiment, if the action defined is to automatically cache the respective data when the respective read-update ratio threshold for the respective data accessed from the respective data source has been exceeded, the third program instructions include instructions to automatically cache the respective data from the respective data source. Preferably, the first, second, third and fourth program instructions are stored on the computer readable medium.

Referring now to FIG. 4, there is illustrated a system 400 for identifying caching opportunities. As depicted, system 400 includes a computer infrastructure 402, which is intended to represent any type of computer architecture that is maintained in a secure environment (i.e., for which access control is enforced). As shown, infrastructure 402 includes a computer system 404 that typically represents a server or the like. It should be understood, however, that although not shown, other hardware and software components (e.g., additional computer systems, such as, routers, firewalls, etc.) could be included in infrastructure 402.

In general, a user (such as, user A, reference numeral 430 through user X, reference numeral 432) may interface with infrastructure 402 for accessing the caching prospector tool 416 configured to identify caching opportunities, which is installed on computer system 404. Similarly, an administrator 446 can interface with infrastructure 402 for supporting and/or configuring the infrastructure 402, such as, upgrading the caching prospector tool 416. In general, the parties could access infrastructure 402 directly, or over a network via interfaces (e.g., client web browsers) loaded on computerized devices (e.g., personal computers, laptops, handheld devices, etc.). In the case of the latter, the network can be any type of network such as the Internet or can be any other network, such as, a local area network (LAN), a wide area network (WAN), a virtual private network (VPN), etc. In any event, communication with infrastructure 402 could occur via a direct hardwired connection (e.g., serial port), or via an addressable connection that may utilize any combination of wire line and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, the parties could utilize an Internet service provider to establish connectivity to infrastructure 402. It should be understood that under the present invention, infrastructure 402 could be owned and/or operated by a party, such as, a provider 444, or by an independent entity. Regardless, use of infrastructure 402 and the teachings described herein could be offered to the parties on a subscription or fee-basis. In either scenario, an administrator 446 could support and configure infrastructure 402, as mentioned herein above.

Computer system or server 404 is shown to include a CPU (hereinafter “processing unit 406”), a memory 412, a bus 410, and input/output (I/O) interfaces 408. Further, computer system 400 is shown in communication with external I/O devices/resources 424 and storage systems 422 through 428. In an embodiment as shown, the infrastructure 402 includes a plurality of storage systems or data sources, such as, storage system 422 that includes data source A, reference numeral 426, up to storage system 428 that includes data source X, reference numeral 429, so that a user A through X (reference numeral 430 through 432) accessing the data sources A through X in the respective storage systems 422 through 428 can be tracked by the caching prospector tool 416 for purposes of identifying caching opportunities. In general, processing unit 406 executes computer program codes, such as, the database manager 414, which is configured to track read-update ratio thresholds for data accessed from one or more databases or storage systems, such as storage system 422 through storage system 428 and the caching prospector tool 416, which is configured to identify caching opportunities when a threshold (read-update ratio threshold) has been exceeded. While executing the database manger 414 and/or the caching prospector tool 416, the processing unit 406 can read and/or write data, to/from memory 412, storage systems 422 and/or 428, and/or I/O interfaces 408. Bus 410 provides a communication link between each of the components in computer system 400. External devices 424 can include any devices (e.g., keyboard, pointing device, display, etc.) that enable a user to interact with computer system 400 and/or any devices (e.g., network card, modem, etc.) that enable computer system 400 to communicate with one or more other computing devices.

Computer infrastructure 402 is only illustrative of various types of computer infrastructures for implementing the invention. For example, in one embodiment, computer infrastructure 402 includes two or more computing devices (e.g., a server cluster) that communicate over a network to perform the various process steps of the invention. Moreover, computer system 400 is only representative of various possible computer systems that can include numerous combinations of hardware. To this extent, in other embodiments, computer system 400 can include any specific purpose computing article of manufacture comprising hardware and/or computer program code for performing specific functions, any computing article of manufacture that includes a combination of specific purpose and general purpose hardware/software, or the like. In each case, the program code and hardware can be created using standard programming and engineering techniques, respectively. Moreover, processing unit 406 may include a single processing unit, or be distributed across one or more processing units in one or more locations, e.g., on a client and server. Similarly, memory 412 and/or storage system 422 can include any combination of various types of data storage and/or transmission media that reside at one or more physical locations. Further, I/O interfaces 408 can include any system for exchanging information with one or more external devices 424. Still further, it is understood that one or more additional components (e.g., system software, math co-processing unit, etc., not shown in FIG. 4) can be included in computer system 400. Similarly, it is understood that the one or more external devices 424 (e.g., a display) and/or storage system(s) 422 could be contained within computer system 404, and not externally as shown.

Storage systems 422 and 428 can be any type of system (e.g., a database) capable of storing information or data, such as, data sources A (reference numeral 426) through X (reference numeral 429). To this extent, storage system 422 could include one or more storage devices, such as a magnetic disk drive or an optical disk drive. In another embodiment, storage systems 422 and 428 includes data distributed across, for example, a local area network (LAN), wide area network (WAN) or a storage area network (SAN) (not shown). Although not shown, additional components, such as cache memory, communication systems, system software, etc., may be incorporated into computer system 400.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for identifying caching opportunities, said method comprising the steps of:
identifying at least one data source among a plurality of data sources utilized by an application, said plurality of data sources being stored on a computer system;
establishing a pre-set respective read-update ratio threshold for respective data accessed from a respective data source among said plurality of data sources, wherein exceeding said pre-set respective read-update ratio threshold for said respective data accessed identifies a caching opportunity;
defining an action to be taken when said pre-set respective read-update ratio threshold for said respective data accessed from said respective data source has been exceeded; and
taking said action defined when said pre-set respective read-update ratio threshold for said respective data accessed from said respective data source has been exceeded.

2. The method according to claim 1, further comprising the step of:
tracking a respective read-update ratio threshold for data accessed from each data source among said plurality of data sources stored on said computer system.

3. The method according to claim 2, wherein said tracking step further comprises the step of:
determining when said pre-set respective read-update ratio threshold for said respective data accessed from said respective data source among said plurality of data sources is exceeded.

4. The method according to claim 3, wherein said taking step further comprises the step of:
checking said action defined before taking said action defined when said read-update ratio threshold for said respective data accessed from said respective data source has been exceeded.

5. The method according to claim 4, wherein said action defined to be taken when said pre-set respective read-update ratio threshold for said respective data accessed from said respective data source has been exceeded comprises at least one of: advise a user of an opportunity to cache said respective data accessed from said respective data source and automatically cache said respective data accessed from said respective data source.

6. The method according to claim 5, wherein if said action defined is to advise said user of said opportunity to cache said respective data when said pre-set respective read-update ratio threshold for said respective data accessed from said respective data source has been exceeded, said method further comprises the steps of:
sending notification to said user that said respective read-update ratio threshold for said respective data accessed from said respective data source has been exceeded; and
inquiring whether said user wants to cache said respective data from said respective data source.

7. The method according to claim 6, wherein if said user wants to cache said respective data from said respective data source, said method further comprises the steps of:
receiving an affirmative response from said user to cache said respective data from said respective data source; and
caching said respective data from said respective data source.

8. A system for identifying caching opportunities, comprising:
an application server configured to ascertain one or more data sources utilized by an application;
a database manager configured to track a respective read-update ratio threshold for data accessed from at least one data source of said one or more data sources in said database; and
a caching prospector tool configured to receive a pre-set respective read-update ratio threshold for respective data accessed from a respective data source of said one or more data sources, said one or more data sources being stored in a database; said caching prospector tool being further configured to take a defined action when said pre-set respective read-update ratio threshold for said respective data accessed from said respective data source has been exceeded, wherein exceeding said pre-set respective read-update ratio threshold for said respective data accessed identifies a caching opportunity.

9. The system according to claim 8, wherein said caching prospector tool is further configured to determine a first use of said respective data accessed from said respective data source and is configured to register with said database manager to receive notification when said pre-set respective read-update ratio threshold for said respective data accessed from said respective data source has been exceeded.

10. The system according to claim 9, wherein said caching prospector tool is further configured to receive notification when said pre-set respective read-update ratio threshold for said respective data accessed from said respective data source has been exceeded.

11. The system according to claim 10, wherein said defined action to be taken when said respective read-update ratio threshold for said respective data accessed from said respective data source has been exceeded comprises at least one of: advise a user of an opportunity to cache said respective data accessed from said respective data source and automatically cache said respective data accessed from said respective data source.

12. The system according to claim 11, wherein if said defined action is to advise said user of said opportunity to cache said data, said caching prospector tool is further configured to inquire whether said user wants to cache said respective data from said respective data source when said respective read-update ratio threshold for said data accessed from said respective data source has been exceeded.

13. The system according to claim 12, wherein said caching prospector tool is further configured to request caching of said respective data from said respective data source upon receiving an affirmative response from said user to cache said respective data.

14. The system according to claim 13, wherein if said defined action is to automatically cache said respective data from said respective data source, said caching prospector tool automatically requests caching of said respective data from said respective data source when said respective read-update ratio threshold for said respective data accessed from said respective data source has been exceeded.

15. A computer program product for identifying caching opportunities, said computer program product comprising:
a computer readable medium;
first program instructions to establish a respective read-update ratio threshold for respective data accessed from a respective data source among a plurality of data sources stored in a database, wherein exceeding said read-update ratio threshold for said respective data accessed identifies a caching opportunity;
second program instructions to define an action to be taken when said respective read-update ratio threshold for said respective data accessed from said respective data source has been exceeded;
third program instructions to take said action defined when said read-update ratio threshold for said respective data accessed from said respective data source has been exceeded; and wherein said first, second and third program instructions are stored on said computer readable medium.

16. The computer program product according to claim 15, further comprising:
fourth program instructions to track a respective read-update ratio threshold for data accessed from each data source among said plurality of data sources stored in said database; and wherein said fourth program instructions are stored on said computer readable medium.

17. The computer program product according to claim 16, wherein said first program instructions include instructions to identify at least one data source among said plurality of data sources utilized by an application; and wherein said action defined to be taken when said respective read-update ratio threshold for said respective data accessed from said respective data source has been exceeded comprises at least one of: advise a user of an opportunity to cache said respective data accessed from said respective data source and automatically cache said respective data accessed from said respective data source.

18. The computer program product according to claim 17, wherein if said action defined is to advise said user of said opportunity to cache said respective data when said respective read-update ratio threshold for said respective data accessed from said respective data source has been exceeded, said third program instructions include instructions to send notification to said user that said respective read-update ratio threshold for said respective data accessed from said respective data source has been exceeded and to inquire whether said user wants to cache said respective data from said respective data source.

19. The computer program product according to claim 18, wherein if said user sends an affirmative response to cache said respective data from said respective data source, said third program instructions include instructions to cache said respective data from said respective data source upon receiving said affirmative response from said user to cache said respective data.

20. The computer program product according to claim 19, wherein if said action defined is to automatically cache said respective data when said respective read-update ratio threshold for said respective data accessed from said respective data source has been exceeded, said third program instructions include instructions to automatically cache said respective data from said respective data source.
